(19) United States
(12) Patent Application Publication
(10) Pub. No.: US 2010/0240512 A1
(43) Pub. Date: Sep. 23, 2010

(54) Method for making a string of bags provided with a cursor

(75) Inventor: Isabelle Moulin, Paris (FR)

Correspondence Address: FOLEY AND LARDNER LLP;SUITE 500, 3000 K STREET NW, WASHINGTON, DC, 20007, US

(73) Assignee: S2F FLEXICO

(21) Appl. No.: 12/659,670

(22) Filed: Mar. 16, 2010

(30) Foreign Application Priority Data
Mar. 18, 2009 (FR) 09 51735

(51) Int. Cl. B31B 1/00

(52) U.S. Cl. 493/267

(57) ABSTRACT

The present invention relates to a method for making a string (C) of packaging bags (S) formed with two walls (21, 22), according to which the following steps are applied:

a) a sheet (2) of plastic material folded on itself longitudinally, or two distinct sheets, are used for delimiting two parallel walls;

b) the connecting region of the walls (21, 22) of said sheet (2) is conformed in order to give it an “M” gusset profile;

c) matching closure profiles are longitudinally attached on the faces opposite this gusset, and then

d) said bags (S) are individualized pairwise by making a separation (25) and a weld perpendicular to said profiles (30, 31),

characterized by the fact that a cursor (5) is placed on said profiles before applying said step d).

The present invention relates to a method for making a string of packaging bags formed with two walls.

An exemplary application of such bags is the conditioning of food products, for example frozen foods.

Documents EP-B-0 205 852 and WO-A-94/19250 describe installations and methods for making packaging bags in plastic material provided with matching opening and closing profiles.

According to these documents, the bags are made in the form of a string of juxtaposed bags, the general direction of latter (i.e. the one which is oriented from the top to the bottom of the bag), being perpendicular to the longitudinal direction of the string.

The bags are joined at their top by a common longitudinal strip—this is referred to as a suspension strip—with which they may be displaced together from station to station for applying different operations.

The object of the present invention is to enhance the method for making such a string.

This therefore relates to a method for making a string of packaging bags formed with two walls, these bags being:

delimited by so-called upper and lower longitudinal edges and transverse edges,

at least partly individualized pairwise, by a separation parallel to said transverse edges,

all interdependent with two longitudinal so-called suspension strips, themselves respectively interdependent with a corresponding wall,

the walls in the vicinity of one of the longitudinal edges and parallel to the latter being provided with matching closure profiles,

according to which the following steps are applied:

a) a sheet of plastic material longitudinally folded on itself or two distinct sheets are used for delimiting said two parallel walls;

b) the connecting region of the walls of said sheet are conformed in order to give it an M-shaped gusset profile;

c) said matching closure profiles are longitudinally attached onto the faces opposite this gusset, and then

d) said bags are individualized pairwise, by making a separation and a weld perpendicular to said profiles,

characterized by the fact that a cursor is placed on said profiles before applying said step d).

According to other advantageous characteristics:

a step a′) is applied according to which a suspension strip is longitudinally attached along each of the free ends of said walls;

said step a′) is applied by welding;

in step a′), said suspension strips are attached on the faces opposite said walls;

in step a′), initially joined strips are used which are separated from each other after placement;

said steps a), a′), b) and c) are applied in this order or in a different order;

in step a), one or two sheets, an edge of which forms a longitudinal suspension strip, are used;

instead and in place of step c), profiles made in the same material as said walls are used.

Other features and advantages of the present invention will become apparent upon reading the detailed description which follows and which will be made with reference to the appended drawings, wherein:

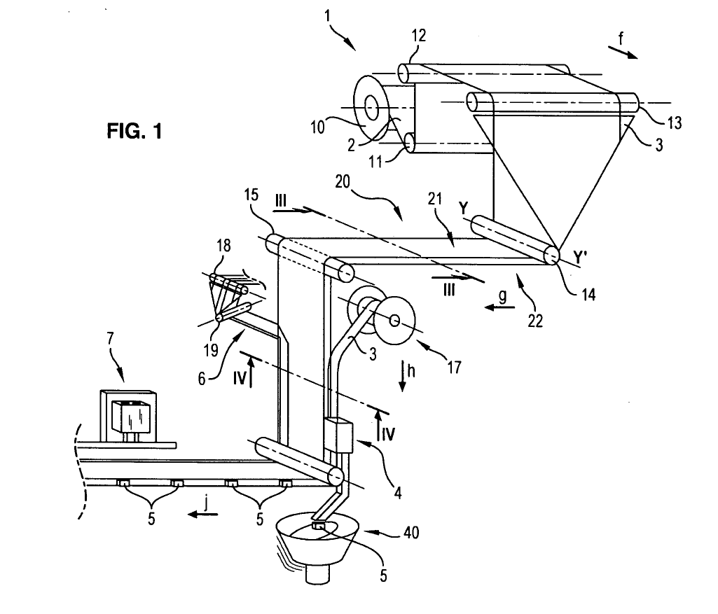

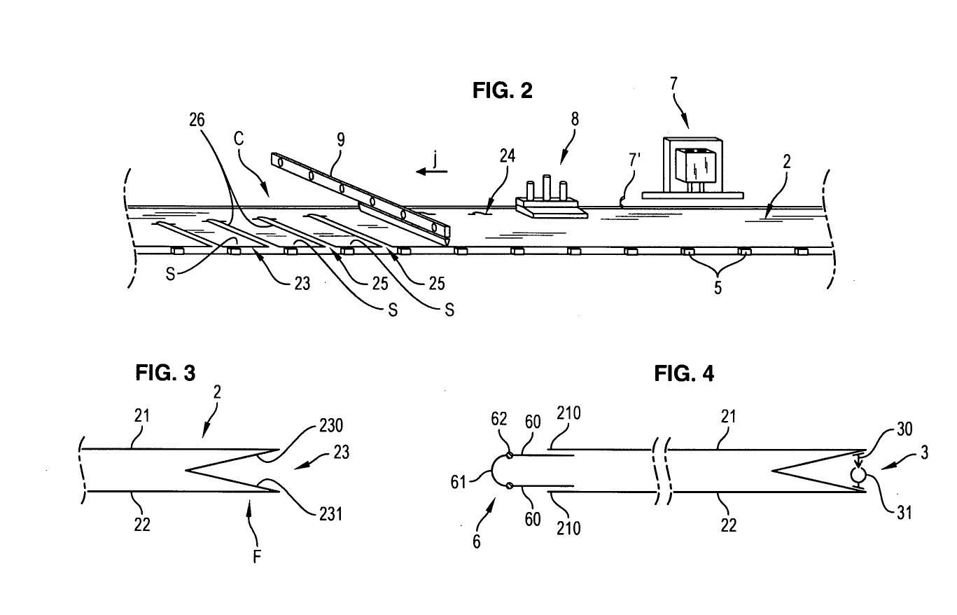

FIGS. 1 and 2 are schematic views of an installation for applying said method, FIG. 1 illustrating the upstream portion of this installation, while FIG. 2 illustrates the downstream portion thereof,

FIG. 3 is a sectional view, along the plane III-III of FIG. 1, of a plastic sheet during transformation according to the method of the invention,

FIG. 4 is a sectional view analogous to that of FIG. 3, along the plane IV-IV of FIG. 1, at a station of the installation located downstream relatively to the previous one.

The method according to the invention may be applied by means of an automated installation such as the one schematically illustrated in FIG. 1.

This installation 1 includes different stations through which a sheet 2 consisting in a film of plastic material passes in transit, and at which it undergoes operations and/or transformations.

In the exemplary embodiment given hereafter, use is made of a single and unique sheet 2 for making bags. However, the use of two different sheets which are attached to each other, for example by welding, may perfectly be contemplated.

Moreover, when the term of “sheet” is used, a mono- or multi-material sheet is meant, in this case a mono- or multi-layer sheet.

The displacement and the progress of the sheet 2 are symbolized by the arrows f, g, h and j of FIGS. 1 and 2.

The station located the most upstream from the installation 1 comprises a rotary roller 10 of axis X-X′, on which said sheet 2 is positioned in the form of a spool. The latter sheet has very great length.

The sheet passes over a series of parallel guide rollers 11, 12 and 13, which give to the sheet a direction of horizontal displacement in the direction of the arrow f.

Once it has crossed the roller 13, the sheet enters into contact with a conformer 3 of a known type, called a “folding triangle” which is capable of folding back the sheet 2 on itself, along a middle fold directed longitudinally.

A horizontal roller 14 with an axis Y-Y′ perpendicular to the three previous rollers, is positioned at the output of the conformer 3, so that once this roller has been passed, the folded sheet undergoes horizontal displacement symbolized by the arrow g.

The sheet then has the configuration illustrated in FIG. 3, which means that it consists of two superposed and parallel walls 21 and 22, connected through a fold 23.

The fold 23 has the shape of an “M” (or of a “W” depending on the direction) gusset, this particular configuration is made possible by the fact that once the roller 14 has been crossed, an elongated member, for example in the form of a finger, is pressed against the fold of the sheet in order to give it this particular configuration.

The sheet is then conveyed by means of two rollers 14 and 16 with an axis Y-Y′, positioned vertically above each other, along a vertical downward trajectory (arrow h).

During this downward movement, the sheet is subject to two different operations.

The first is applied at the longitudinal free edge 210 of the walls 21 and 22 of the sheet, as this appears in FIG. 4.

This is the placement of a so-called “suspension sheet” 6 which is attached along the free edge 210 of the walls 21 and 22 of the sheet 2.

This is a suspension sheet conveyed by guide rollers referenced as 18 and 19 which, with a conformer similar to the one already described, proceed with its folding and allow it to be engaged, as shown in FIG. 4, against the faces opposite the walls 21 and 22 of the sheet 2.

The sheet 6 initially consists of two parallel strips 60 connected through a fold 61 as a circular arc, their mutual junction areas being provided with a bulge or ring 62.

However, in an alternative embodiment, it may be perfectly contemplated that the strips 60 be of a single piece with the walls 21 and 22 of which they then form the extension. In this case, the ring 62 may be formed by winding the free edge of the strips 60 over itself and by fusion of this winding.

On the other side of the sheet 2, i.e. at the gusset F, it is proceeded with two different operations.

The first is performed by means of a roller 17 on which a strip 3 is wound, formed with two matching closure profiles 30 and 31 engaged with each other.

These are well-known matching profiles, already used on many packaging bags and the matching closure members of which for example consist of male and female elements, hooks, or any other means of this kind.

At this station, the strip 3 is placed inside the gusset F, so that the matching profiles 30 and 31 are placed facing each other, against the faces 230 and 231 of the gusset F. Attachment at this level is for example achieved by welding.

In an alternative embodiment, use may be made of a sheet 2, the profiles 30 and 31 of which are made in the same material thereof.

It is then immediately proceeded with the placement on these profiles of a set of cursors 5 of a type known per se.

These are cursors capable of actuating said profiles, respectively upon opening and closing, by displacement along the latter.

These cursors are stored in a vibrating bowl 40 and placed on the profiles by a robot 4.

This placement, achieved by moving the wings apart of the cursors, is of course accomplished sequentially, so that an identical pitch separates both neighboring cursors along the sheet 2.

Once this sheet has crossed the roller 16, it then undergoes strictly horizontal displacement (see FIG. 2). It is then conveyed to a station 7, in which the welding of the suspension sheet 6 between the walls 21 and 22 of the sheet 2 is carried out. More specifically, the strips 60 parallel to the faces opposite the walls 21 and 22 are welded.

Immediately upon exiting this station, the cutting-out of the sheet 6 is performed by means of a blade 7, in order to open the fold 61 and separate the longitudinal strips 60 from each other.

At a station 8, alternating cut-outs 24 of both walls 21 and 22 are made, intended to subsequently facilitate the opening of the individualized bags.

Finally, at the station 9, individualization of the bags is performed, this by means of a blade with transverse orientation, which materializes a separation 25 and simultaneously proceeds with welding the walls 21 and 22 in order to define the transverse edges of the bags.

Upon exiting this station, the bags S then appear in the form of a string C, all interdependent with the suspension strips 60.

At this stage, the string of bags (and their associated suspension strips) is conditioned. It will be subsequently used for filling the bags.

In one alternative, it is however possible to directly proceed with this operation.

In this case, this string may then be given a vertical orientation, so that the bags are “suspended” from the strips 60.

Filling them through the opening formed by the space located between two alternating cut-outs 24 may then be contemplated.

During this operation, the foodstuffs flow along the strips 60 towards the inside of the bags S, without any risk of retaining material at this level.

Once they are filled, the bags are closed by means of a welding line which extends on the side and parallel to the alternating cut-outs 24.

Finally, it is proceeded with separating the bags, by a longitudinal cut-out, made just above the aforementioned welding line.

According to the invention, the placement of the bags on the sheet 2 before individualization of the bags is accomplished in a particularly performing way since the sheet at this stage has a unitary character, which means that it does not deform very much.

If on the other hand placement of the cursors is contemplated once the bags are individualized, they will then have to be maintained in place individually, which would be particularly restricting.

The first opening of the bags is accomplished by displacing the cursors 5 along the profiles 30 and 31 and by perforating the gusset F. In order to facilitate this operation, a pre-cut of the sheet may be contemplated.

Finally, it will be noted that it is possible to first attach the profiles 30 and 31 on the walls 21 and 22, and then to engage the cursor 5 onto the latter. Alternatively, first engaging the cursor on the profiles and then attaching this assembly onto the walls may also be contemplated.

1.-8. (canceled)

9. A method for making a string of packaging bags formed with two walls, these bags being:
delimited by so-called upper and lower longitudinal edges, and by transverse edges,
at least partly individualized pairwise by a separation parallel to said transverse edges,
all interdependent with two longitudinal so-called suspension strips, themselves interdependent with a corresponding wall, respectively,
the walls being provided in the vicinity of one of the longitudinal edges and parallel to the latter, with matching closure profiles,
according to which the following steps are applied:
a) a sheet of plastic material folded on itself longitudinally or two distinct sheets are used for delimiting said two parallel walls;
b) the connecting region of the walls of said sheet is conformed in order to give it an M-shaped gusset profile;
c) said matching closure profiles are attached on the faces opposite this gusset, and, next
d) said bags are individualized pairwise by making a separation and a weld perpendicular to said profiles,
wherein a cursor is placed on said profiles before applying said step d).

10. The method according to claim 9, wherein step a′) is applied according to which a suspension strip is longitudinally attached along each of the free edges of said walls.

11. The method according to claim 10, wherein step a′) is applied by welding.

12. The method according to claim 10, wherein in step a′) said suspension strips are attached onto the faces opposite said walls.

13. The method according to claim 10, wherein in step a′) initially joined strips are used which are separated from each other after placement.

14. The method according to claim 10, wherein said steps a), a′), b) and c), are applied in this order or in a different order.

15. The method according to claim 9, wherein in step a), one or two sheets, one end of which forms a longitudinal suspension strip, are used.

16. The method according to claim 9, wherein instead and in place of step c), profiles made in the same material as said walls, are used.

17. The method according to claim 11, wherein in step a′) said suspension strips are attached onto the faces opposite said walls.
